(19) United States
(12) Patent Application Publication
(10) Pub. No.: US 2010/0262582 A1
(43) Pub. Date: Oct. 14, 2010

(54) CONTENT SYNCHRONIZATION ACROSS MULTIPLE COMPUTERS

(75) Inventors: Francisco J. Garcia-Ascanio, Redmond, WA (US); Michael F. Palermiti, Issaquah, WA (US); Scott R. Ramsby, Kirkland, WA (US); Dejan D. Subotic, Kirkland, WA (US); Brian D. Remick, Snoqualmie, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/421,991

(22) Filed: Apr. 10, 2009

(51) Int. Cl. G06F 17/30; G06F 15/16; G06F 3/048

(52) U.S. Cl. 707/634; 707/E17.005; 709/227; 715/764

(57) ABSTRACT

Methods and systems provide a tool for synchronizing content across multiple computers. In one or more embodiments, files and folders can be automatically synchronized when multiple computers are available. Further, in at least some embodiments, automatic synchronization can be effected on each of two or more computers by a single user action on a single computer, such as a mouse click. Additionally, in other embodiments, the tool can present an option to synchronize content across multiple computers.

### BACKGROUND

Currently, file synchronization technologies that enable users to synchronize files across multiple computers are complicated and can be confusing to both experienced and inexperienced users.

For example, file synchronization typically utilizes a multi-step process in order for a user to synchronize files across multiple computers. In some approaches, in order to synchronize content on two computers, synchronization software must be installed and configured on both computers and both computers must typically be online. Following this, in web-based scenarios, the user then navigates to a website to effect the synchronization. Once there, the user typically manually selects folders or files that the user wishes to synchronize between both computers. After selecting the folders or files to synchronize, the user then designates a location to which selected folders or files are to be mapped.

By following these steps, the user can synchronize a first computer's folders or files with a second computer. However, if the user wishes to synchronize the second computer's folders or files with the first computer, the user must typically repeat these steps at the second computer. Needless to say, this can be confusing and time-consuming for the average user.

Compounding the difficulties associated with synchronization is the fact that a user must typically have a familiarity with a computer's directory structure in order to determine which folders and files to synchronize. An average user may lack this familiarity thus making synchronization even more challenging.

### SUMMARY

Methods and systems provide a tool for synchronizing content across multiple computers. In one or more embodiments, files and folders can be automatically synchronized when multiple computers are available. Further, in at least some embodiments, automatic synchronization can be effected on each of two or more computers by a single user action on a single computer, such as a mouse click. Additionally, in other embodiments, the tool can present an option to synchronize content across multiple computers.

### BRIEF DESCRIPTION OF THE DRAWINGS

FIG. 1 illustrates an operating environment in accordance with one or more embodiments.

FIG. 2 is a flow diagram that describes steps in a method in accordance with one or more embodiments.

FIG. 3 is a flow diagram that describes steps in a method in accordance with one or more embodiments.

FIG. 4 is a flow diagram that describes steps in a method in accordance with one or more embodiments.

FIG. 5 illustrates a user interface in an implementation example in accordance with one or more embodiments.

FIG. 6 illustrates an implementation example in accordance with one or more embodiments.

FIG. 7 is a block diagram of an example system that can be utilized to implement one or more embodiments.

### DETAILED DESCRIPTION

Overview

Methods and systems provide a tool for synchronizing content across multiple computers. In one or more embodiments, files and folders can be automatically synchronized when multiple computers are available. Further, in at least some embodiments, automatic synchronization can be effected on each of two or more computers by a single user action on a single computer, such as a mouse click. Additionally, in other embodiments, the tool can present an option to synchronize content across multiple computers.

In one described embodiment, a software component referred to as a synchronization client synchronizes files and folders across one or more computers automatically, in response to a synchronization command on one of the computers. Thereafter, the synchronization client automatically synchronizes files and folders, in response to changes in the files and folders, once a communication connection is established between computers on which synchronization is to occur.

In the discussion that follows, a section entitled “Operating Environment” is provided and describes an environment in which the various embodiments may operate. Following this, a section entitled “Example Methods” describes example methods in accordance with one or more embodiments. After that, a section entitled “Implementation Example” provides and describes some example implementations. Finally, a section entitled “Example System” is provided and describes a structural example of a system that can be utilized to implement one or more embodiments.

Operating Environment

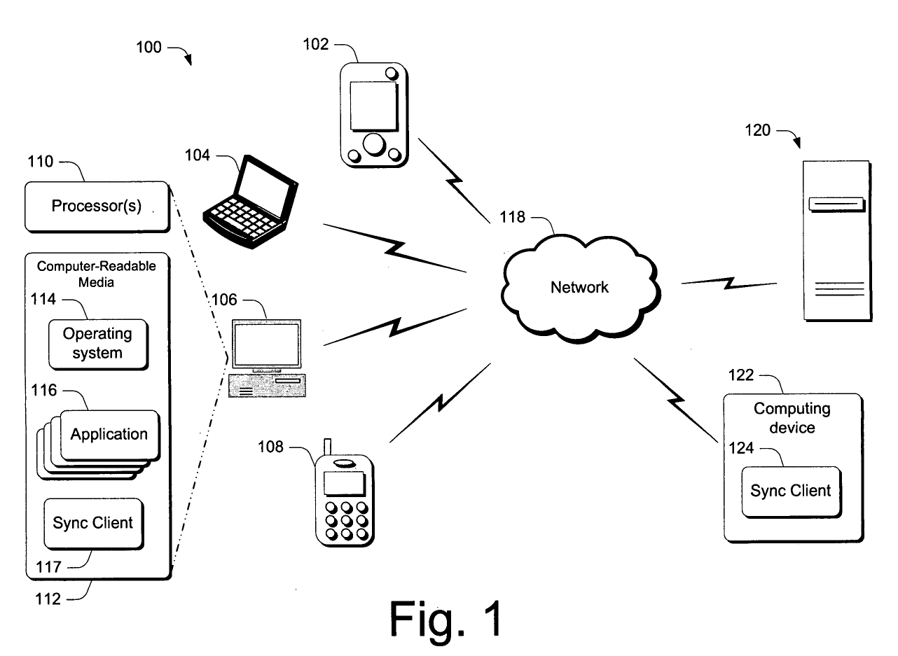

FIG. 1 illustrates an operating environment in accordance with one or more embodiments, generally at 100. Operating environment 100 includes multiple different computing devices, examples of which are shown at 102, 104, 106, and 108. The computing devices can be used by a user to consume or otherwise interact with content, examples of which can include content utilized by the synchronization client described below. Individual computing devices can typically include one or more processors 110, one or more computer-readable storage media 112, an operating system 114 and one or more applications 116 that reside on the computer-readable storage media and which are executable by the processor(s).

In addition, in one or more embodiments, computer-readable storage media 112 can include software in the form of a synchronization client 117 that synchronizes files, databases or other information, such as that described herein. For example, the synchronization client can synchronize files or folders across multiple computers as described above and below.

The computer-readable storage media can include, by way of example and not limitation, all forms of volatile and non-volatile memory and/or storage media that are typically associated with a computing device. Such media can include ROM, RAM, flash memory, hard disk, removable media and the like.

In addition, in at least some embodiments, environment 100 includes a network 118, such as a local network, peer-to-peer network, or the Internet, via which content can be received and sent. Content and other data or information can be received over network 118 by way of a server 120 that has access to the content and/or information associated with the content. The server can provide a means for one or more of computing device 102, 104, 106, and 108 to communicate with another computing device 122 via network 118. In at least some embodiments, any or all of the computing devices can receive content and/or information associated with the content over network 118. Additionally, in at least some embodiments, any or all of the computing devices can include a synchronization client 124.

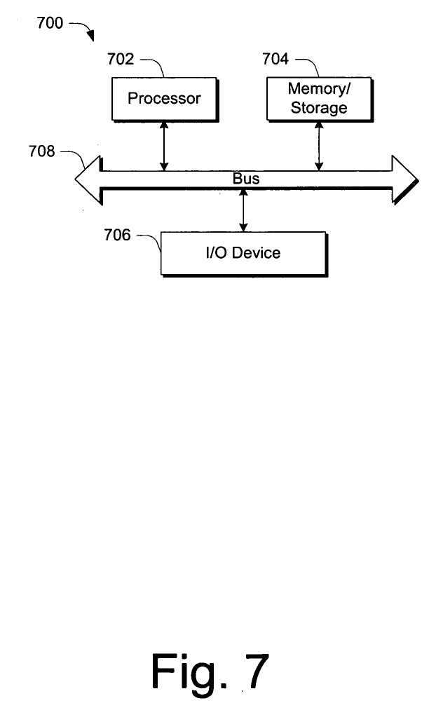

The computing devices can be embodied as any suitable computing device such as, by way of example and not limitation, a desktop computer (such as computing device 106), a portable computer (such as computing device 104), a handheld computer such as a personal digital assistant (such as computing device 102), a cell phone (such as computing device 108), and the like. One example of a computing device is shown and described below in relation to FIG. 7.

Having discussed the general notion of an example operating environment in which various embodiments can operate, consider now a discussion of example methods of operation in accordance with one or more embodiments.

### EXAMPLE METHODS

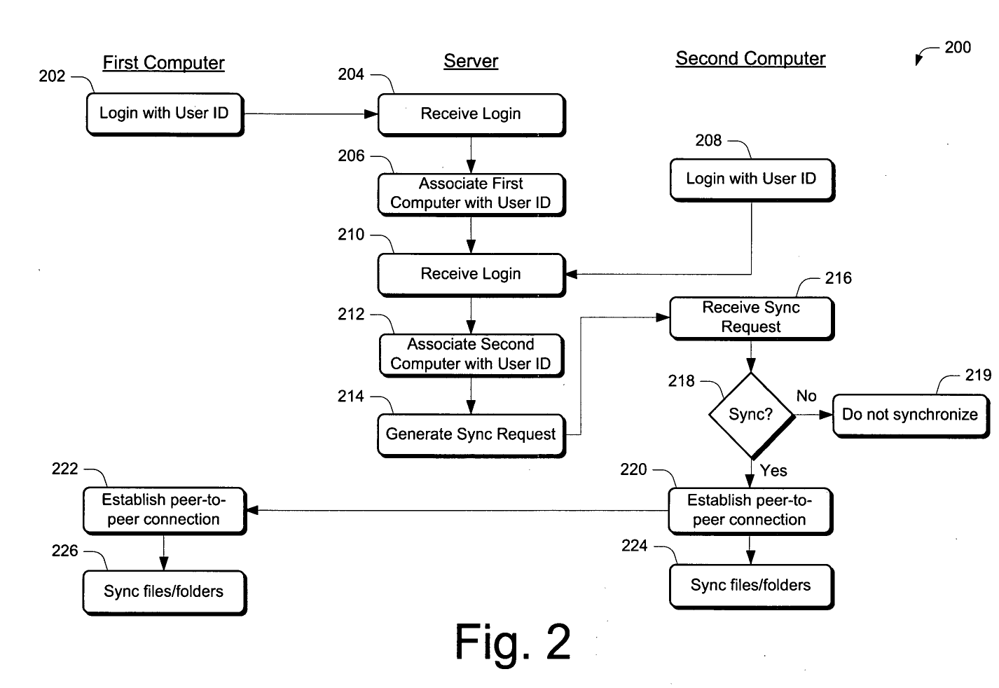

FIG. 2 is a flow diagram that describes steps in a method in accordance with one or more embodiments generally at 200. The method can be implemented in connection with any suitable hardware, software, firmware or combination thereof. In at least some embodiments, the method can be implemented using a system such as the one described above. In the illustrated flow diagram, various steps are illustrated as being performed by either a first computer, a server, or a second computer.

Step 202 receives a login associated with a user identification (ID) and sends login information to a server. This step can be performed in any suitable way. For example, in one or more embodiments, a graphical user interface can be presented to the user to enable the user to enter login information such as a user identification and password. In one or more embodiments, a user's identity is established with the server prior to the login step. For example, the user may have already subscribed with or associated themselves with the server. Step 204 receives login information from the first computer. Step 206 associates the first computer with the user ID after receiving the login from the first computer. This step can be performed in any suitable way. For example, an individual computer may have an associated identifier such as a GUID. In at least some embodiments, the GUID can be associated with the user's login information.

Step 208 receives, at a second computer (or additional computers), a login associated with the same user ID and sends login information to the server. This step can be performed in any suitable way an example of which is described above. In one or more embodiments, a user's identity is established with the server prior to the login step. For example, the user may have already subscribed with or associated themselves with the server. Step 210 receives login information from the second computer. Responsive to receiving the login information from the second computer, step 212 associates the second computer with the user ID. An example of how this can be done is provided above.

Step 214 generates a synchronization request and sends the synchronization request to the second computer. This step can be performed in any suitable way. For example, in at least some embodiments, the server can send a message or other data to the second computer over a network, such as the Internet or local network. The synchronization request can be configured to ask the user if they wish to synchronize files or folders on the second computer with files or folders on the first computer.

Step 216 receives the synchronization request from the server and presents the synchronization request to the user. This step can be performed in any suitable way. For example, in at least some embodiments, a graphical user interface can be used to present the synchronization request to the user. In one or more embodiments, the user can be automatically presented with the synchronization request a single time upon logging on with the second computer. This synchronization request, if selected by the user, can then be used as a basis to automatically synchronize a user's folders or files during subsequent sessions, without necessarily asking the user again whether they wish to synchronize files or folders. For example, the next time the user logs into the first computer, if there is an available connection with the second computer, synchronization can be automatically performed without asking the user.

Step 218 ascertains whether the user has opted to synchronize their files or folders across multiple computers. If the user opts to not synchronize their files or folders, step 219 does not perform synchronization operations. In at least some embodiments, if the user opts to not synchronize their files or folders, the user will not be presented with another synchronization request at either the first or second computers when they log in. Of course, the user may select to synchronize files or folders at a later date by, for example, selecting a command in a menu, through an application interface. This action can be performed on either the first, second, or multiple other computers that a user may log in with.

If, on the other hand, the user opts to synchronize their files or folders, a number of steps can be performed. For example, in at least some embodiments, if a user wishes to synchronize files or folders, a message can be sent to the server indicating that the user wises to synchronize. Each computer can then send information to the server concerning which files or folders each computer has so that the server can create aggregated file and folder inventory information concerning the user's files and folders. Each computer, using this aggregated file and folder inventory information retrieved from the server, can attempt to make a peer-to-peer connection. Accordingly, steps 220 and 222 attempt to establish a peer-to-peer connection between the second computer and the first computer. The peer-to-peer connection can be established in any suitable way. Once a peer-to-peer connection is established between the first and second computers, steps 224 and 226 synchronize files and folders on the second computer with files and folders on the first computer using the peer-to-peer connection. Steps 224 and 226 can be performed in any suitable way. For example, in at least some embodiments, a synchronization client, such as the one described above and below, can direct automatic synchronization of common and/or specific files and folders without the need for a user to manually select files and folders to synchronize. This can be done by one computer by providing descriptions of its folder structure and/or files to a second computer. Differences in the folder structure and/or files can be identified by the second computer which can then create a synchronized folder structure and request new or different files from the first computer. It is to be appreciated and understood, however, that in an event that a peer-to-peer connection cannot be established, each computer can send its file and folder data through the server, with the server acting as a gateway to allow computers that cannot communicate in a peer-to-peer fashion to nonetheless send each other file and folder data for synchronization.

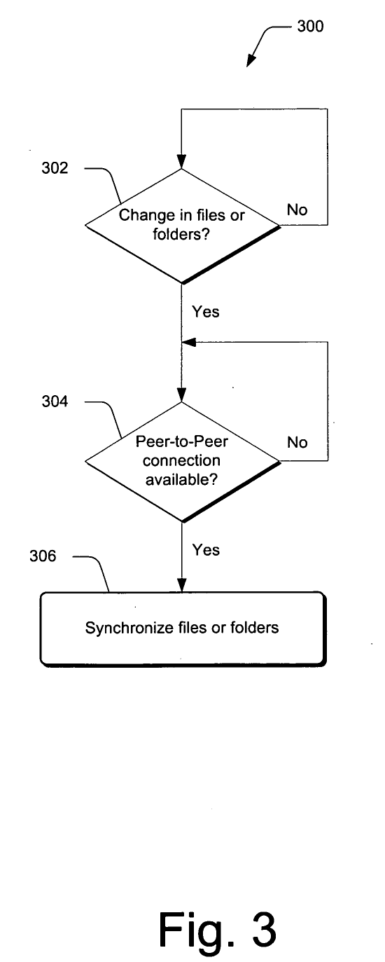

FIG. 3 is a flow diagram that describes steps in a method in accordance with one or more embodiments generally at 300. The method can be implemented in connection with any suitable hardware, software, firmware or combination thereof. In at least some embodiments, the method can be implemented using a system such as the one described above.

Assuming that a user has previously opted to synchronize files and/or folders between at least two computers, step 302 determines whether there has been a change in the files or folders. This step can be performed in any suitable way. For example, the synchronization client can periodically check or monitor files or folders that have previously been selected for synchronization. If no changes are detected, then step 302 does not perform any synchronization operations, but continues to monitor the files or folders for changes. If, however, changes are detected, the synchronization client can send a change notification request to the server. If the server approves the change notification request, e.g., no other changes were received that conflict with the current request, step 304 determines whether a peer-to-peer connection is available. If no peer-to-peer connection is available, step 304 does not perform any synchronization operations, but continues to check, either periodically or persistently, until a peer-to-peer connection is subsequently available. Once a peer-to-peer connection is available, step 306 synchronizes files or folders between at least two computers using the peer-to-peer connection.

The method described in FIG. 3 can be performed in any suitable way. For example, the method can be performed automatically by a synchronization client, such as the one described above and below, without subsequent user interaction. For example, once a user initially opts to synchronize their files or folders, the method can subsequently be performed automatically and even without the user's knowledge.

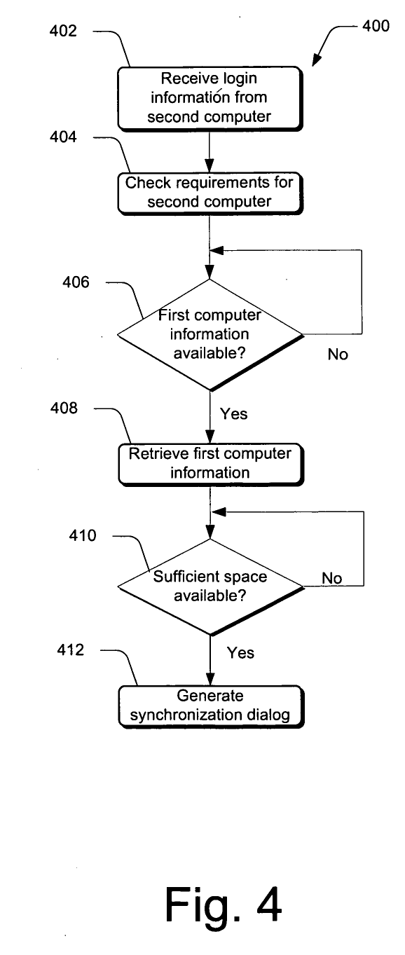

FIG. 4 is a flow diagram that describes steps in a method in accordance with one or more embodiments generally at 400. The method can be implemented in connection with any suitable hardware, software, firmware or combination thereof. In at least some embodiments, the method can be implemented using a system such as the one described above. In the illustrated flow diagram, various steps can be performed by a suitably configured server. The description below assumes that login information from a first computer has previously been received by the server and an association between the first computer and a user ID has previously been established.

Step 402 receives login information from a second computer. Following this, step 404 checks requirements for the second computer. This step can be performed in any suitable way. For example, a list or information of client synchronization requirements can be received, including, but not limited to, information such as disk space, size of folders, and numbers of folders or files to be synchronized.

Step 406 determines whether information from the first computer is available. If the first computer's information is unavailable, then step 406 can continue to monitor or periodically check for the availability of the information or step 406 can end the method. If, however, information from the first computer is available, step 408 retrieves the information. The first computer's information can be available by virtue of having been previously uploaded to the server. Such information can be in the form of a list including, but not limited to, disk space, size of folders, and numbers of folders and files to be synchronized.

Step 410 determines if there is sufficient space available for synchronization on both the first and second computers based on a comparison of the information of synchronization requirements received from the first and second computers. If step 410 determines that there is insufficient space available on the first and/or second computers for synchronization, then no synchronization operations take place. Further, no synchronization dialog will be displayed for the user due to the lack of sufficient space for synchronization of files or folders. Step 410 effectively conducts a client pre-check in order to protect system resources by disallowing synchronization operations if doing so would adversely impact a particular computer. It is to be appreciated, however, that in at least some embodiments, the user can still attempt to synchronize manually using a suitably configured menu. With this menu, the user can ascertain which requirements were not met and, in at least some instances, bypass the pre-check to manually set up a synchronization relationship.

If, on the other hand, step 410 determines that sufficient space is available on the first and second computers for synchronization, then step 412 generates a synchronization dialog consistent with step 214 in FIG. 2 described above. In scenarios where a user has already opted to synchronize computers, step 412 is skipped and synchronization operations can be conducted automatically.

### IMPLEMENTATION EXAMPLE

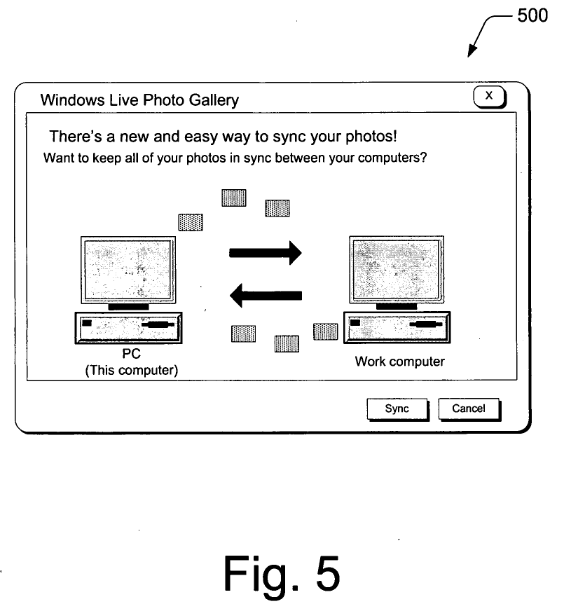

FIG. 5 illustrates a user interface in an implementation example in accordance with one or more embodiments. The description below assumes that login information has previously been received by the server and an association between a user ID and at least two computers has previously been established.

In one or more embodiments, a synchronization dialog is displayed on a user interface shown generally at 500 requesting synchronization of the computers associated with the user ID. The synchronization dialog can be in any suitable form, such as, for example, a popup window or balloon displaying a text and/or a visual representation of each computer associated with the user ID. Further, the synchronization dialog can include instructions or a link to a different location including instructions for implementing a synchronization process between the computers. In addition, the synchronization dialog can include at least an option to synchronize folders and/or files and an option to cancel synchronization.

If a user opts to cancel the synchronization, no synchronization process takes place. If, however, the user opts to synchronize, then a synchronization relationship can be established. Through the synchronization relationship, folders and/or files can be automatically synchronized, for example, once a peer-to-peer connection is established between the first and second computers, as described above. The synchronization relationship can enable files and folders to be synchronized both currently and, automatically in the future. In at least some embodiments, an application running the synchronization client can determine the types of folders and/or files that are to be mapped when the user opts to synchronize. For example, FIG. 5 shows a dialog provided by Windows® Live Photo Gallery in association with a Windows® Live Sync Client. In this example, the types of folders and/or files that are automatically mapped are those associated with Windows® Live Photo Gallery, including but not limited to: photos, videos, public photos, public videos, and any folders, hidden or otherwise, containing original files.

Additionally, any other folders and/or files associated with the application running the synchronization client can also be mapped. Such folders and/or files can include, for example, text documents, spreadsheets, audio files and other types of media files, and any other type of file associated with an application that the user can use to log in and provide login information that can be maintained by a server.

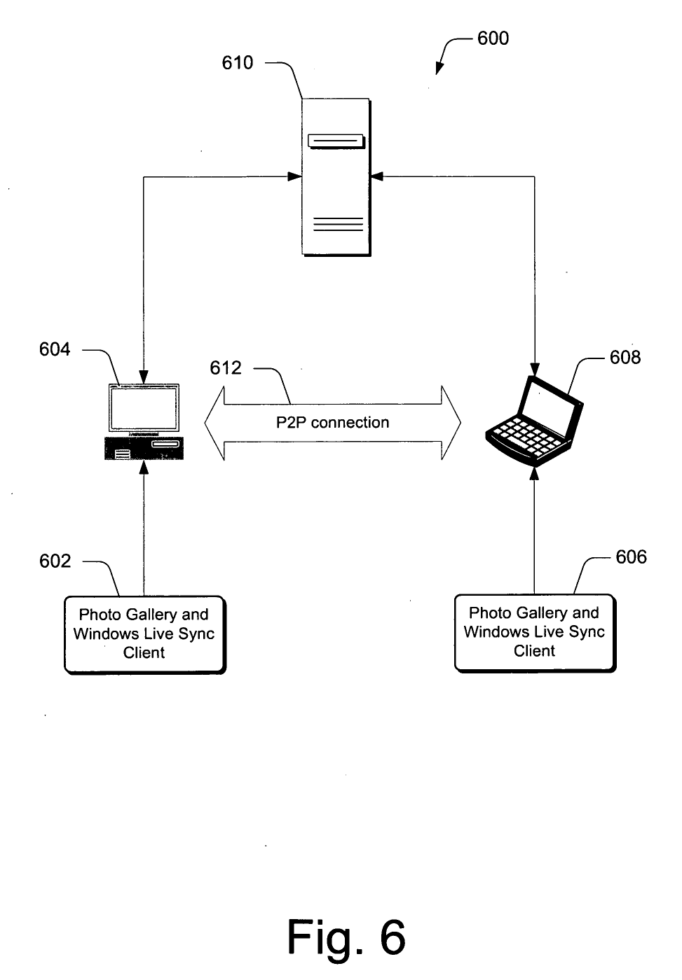

Consider now an implementation example in accordance with one or more embodiments illustrated in FIG. 6 generally at 600. In at least some embodiments, an application 602 is installed on a computer 604 in association with a synchronization client. The application can comprise any suitable type of application such as, by way of example and not limitation, Windows® Live Photo Gallery. Login information for a user is sent from computer 604 to a server 610. The server 610 stores an association between computer 604 and a user ID associated with the login information as discussed above.

Thereafter, an application 606 can be installed on a second computer 608 in association with a synchronization client. For example, Windows® Live Photo Gallery, along with a Windows® Live Sync Client can be installed on computer 608. After installation, login information is sent from computer 608 to server 610. The server 610 stores an association between computer 608 and a user ID associated with the login information. Assuming the login information from computer 608 includes the same user ID that was included in the login information from computer 604, the server 610 can then associate both computers 604 and 608 with the same user ID.

Following this, in at least some embodiments, the server can perform a pre-check on computers 604 and 608 to determine whether both computers have sufficient space to synchronize files or folders. Assuming both computers 604 and 608 have sufficient space to synchronize files or folders, the server 610 then sends a synchronization dialog to computer 608 asking the user whether they wish to synchronize their files or folders between computers 604 and 608. If the synchronization request is affirmed, then server 610 provides information to computer 608 about computer 604 sufficient for computer 608 to attempt to establish a peer-to-peer connection with computer 604. Additionally, the server 610 provides similar information about computer 608 to computer 604 sufficient for computer 604 to establish a peer-to-peer connection. Once a peer-to-peer connection is established between computers 604 and 608, folders and files are synchronized across both computers.

In at least some embodiments, the types of folders and/or files that are automatically synchronized are those that are associated with the application running the synchronization client. For instance, in the example described above, the application running the synchronization client is Windows® Live Photo Gallery. As described above, the types of folders and files that are associated with Windows® Live Photo Gallery include photos, videos, public photos, public videos, and other files that the user may have associated with the application. Additionally, hidden folders containing original files can also be associated with Windows® Live Photo Gallery and will also be automatically synchronized.

As noted above, in at least some embodiments, a synchronization dialog can be presented to a user that enables the user to have their files and/or folders automatically synchronized by a single user input, such as a single mouse click. By automatically synchronizing the user's files and/or folders responsive to a single click on the synchronization dialog, the user is relieved of the burden of having to individually select folders and/or files for synchronization. This, in turn, can enhance a user's experience, particularly for those users who may be unfamiliar with the nuances of file/folder synchronization.

Having discussed example embodiments in which a user's files and/or folders can be synchronized, consider now a discussion of an example system that can be utilized to implement the functionality described above.

### EXAMPLE SYSTEM

FIG. 7 illustrates an example computing device 700 that can implement the various embodiments described above. Computing device 700 can be, for example, various computing devices or servers, such as those illustrated in FIG. 1 or any other suitable computing device.

Computing device 700 includes one or more processors or processing units 702, one or more memory and/or storage components 704, one or more input/output (I/O) devices 706, and a bus 708 that allows the various components and devices to communicate with one another. Bus 708 represents one or more of any of several types of bus structures, including a memory bus or memory controller, a peripheral bus, an accelerated graphics port, and a processor or local bus using any of a variety of bus architectures. Bus 708 can include wired and/or wireless buses.

Memory/storage component 704 represents one or more computer storage media. Component 704 can include volatile media (such as random access memory (RAM)) and/or nonvolatile media (such as read only memory (ROM), Flash memory, optical disks, magnetic disks, and so forth). Component 704 can include fixed media (e.g., RAM, ROM, a fixed hard drive, etc.) as well as removable media (e.g., a Flash memory drive, a removable hard drive, an optical disk, and so forth).

One or more input/output devices 706 allow a user to enter commands and information to computing device 700, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Methods and systems provide a tool for synchronizing content across multiple computers. In one or more embodiments, files and folders can be automatically synchronized when multiple computers are available. Further, in at least some embodiments, automatic synchronization can be effected on each of two or more computers by a single user action on a single computer, such as a mouse click. Additionally, in other embodiments, the tool can present an option to synchronize content across multiple computers.

Although embodiments have been described in language specific to structural features and/or methodological steps, it is to be understood that the embodiments defined in the appended claims are not necessarily limited to the specific features or steps described. Rather, the specific features and steps are disclosed as example forms of implementing the claimed embodiments.

What is claimed is:

1. A computer-implemented method comprising:
receiving, at a computer, a synchronization request from a server, the synchronization request being configured to enable a user to synchronize files or folders with files or folders on one or more other computers;
responsive to receiving the synchronization request, presenting a graphical user interface on the computer to enable the user to synchronize the files or folders on the computer with files or folders on the one or more other computers; and
responsive to the user opting to synchronize files or folders on the computer, attempting to establish a peer-to-peer connection between the computer and the one or more other computers.

2. The computer-implemented method of claim 1, wherein the presenting a graphical user interface is performed automatically when the user performs a log on at the computer.

3. The computer-implemented method of claim 1, further comprising responsive to establishing the peer-to-peer connection, synchronizing the files or folders on the computer with the files or folders on the one or more other computers, wherein the synchronizing is performed without having a user manually select files or folders to synchronize.

4. The computer-implemented method of claim 1, wherein the graphical user interface is configured to enable a user to select synchronization via a single user action.

5. The computer-implemented method of claim 1, wherein the graphical user interface is configured to enable a user to select synchronization via a single user action comprising a mouse click.

6. The computer-implemented method of claim 1, further comprising responsive to establishing the peer-to-peer connection, synchronizing the files or folders on the computer with the files or folders on the one or more other computers, wherein the synchronizing is performed without having a user manually select files or folders to synchronize and wherein the graphical user interface is configured to enable a user to select synchronization via a single user action.

7. The computer-implemented method of claim 1, further comprising responsive to establishing the peer-to-peer connection, synchronizing the files or folders on the computer with the files or folders on the one or more other computers, wherein the synchronizing is performed without having a user manually select files or folders to synchronize and wherein the graphical user interface is configured to enable a user to select synchronization via a single user action comprising a mouse click.

8. The computer-implemented method of claim 1 further comprising:
responsive to the user opting to synchronize files or folders, determining whether there has been a change in synchronized files or folders; and
responsive to a change in the synchronized files or folders, automatically synchronizing the files or folders on the computer with the files or folders on the one or more other computers without subsequent user interaction.

9. The computer-implemented method of claim 8 further comprising:
prior to automatically synchronizing the files and folders, determining whether a peer-to-peer connection is available between the computer and the one or more other computers; and
responsive to a peer-to-peer connection being available, automatically synchronizing the files or folders on the computer with the files or folders on the one or more other computers.

10. A system comprising:
one or more computer-readable storage media; and
a synchronization client embodied on the one or more computer-readable storage media;
wherein the synchronization client is configured to enable files or folders on one computer to be automatically synchronized with files or folders on one or more other computers responsive to a single user input via a graphical user interface and without having a user manually select files or folders to be synchronized.

11. The system of claim 10, wherein the single user input comprises a mouse click.

12. The system of claim 10, wherein the synchronization client is configured to enable synchronization automatically when the user performs a log on on at least one of the computers.

13. The system of claim 10, wherein the synchronization client is configured to determine whether there has been a change in synchronized files or folders and, if so, automatically synchronize the files or folders on the one computer with the files or folders on the one or more other computers.

14. The system of claim 13, wherein the synchronization client is configured to synchronize the files or folders on the one computer with the files or folders on the one or more other computers without subsequent user interaction.

15. The system of claim 10, wherein the files or folders are associated with content comprising photos.

16. The system of claim 10, wherein the files or folders are associated with content other than photos.

17. The system of claim 10, wherein the files or folders are associated with an application that is configured to run the synchronization client.

18. One or more computer-readable storage media embodying computer-executable instructions which, when executed, implement a method comprising:
receiving, at a computer, a synchronization request from a server, the synchronization request being configured to enable a user to synchronize files or folders with files or folders on one or more other computers;
responsive to receiving the synchronization request, presenting a graphical user interface on the computer to enable the user to synchronize the files or folders on the computer with files or folders on the one or more other computers;
responsive to the user opting to synchronize files or folders on the computer, establishing a peer-to-peer connection between the computer and the one or more other computers;
using the peer-to-peer connection to synchronize the files or folders on the computer with the files or folders on the one or more of the computers, wherein synchronizing is performed without having a user manually select files or folders to synchronize and wherein the graphical user interface is configured to enable a user to select synchronization via a single user action.

19. The one or more computer-readable storage media of claim 18, wherein the single user action comprises a mouse click.

20. The one or more computer-readable storage media of claim 18, wherein the method further comprises:
responsive to the user opting to synchronize files or folders, determining whether there has been a change in synchronized files or folders; and
responsive to a change in the synchronized files or folders, automatically synchronizing the files or folders on the computer with the files or folders on the one or more other computers without subsequent user interaction.
